(19) United States
(12) Patent Application Publication
(10) Pub. No.: US 2026/0232133 A1
(43) Pub. Date: Aug. 13, 2026

(54) COOKING METHOD USING MULTIPLE COOKING APPLIANCES

(71) Applicant: Haier US Appliance Solutions, Inc., Wilmington, DE (US)

(72) Inventors: Jongdeok Jang, Incheon (KR); MyungGeon Chung, Seoul (KR)

(21) Appl. No.: 19/052,106

(22) Filed: Feb. 12, 2025

(51) Int. Cl. A47J 36/32; A23B 2/82; A47J 37/06

(52) U.S. Cl. CPC A47J 36/321; A23B 2/82; A47J 37/0623

(57) ABSTRACT

A method of operating a plurality of cooking appliances includes receiving, by a first cooking appliance of the plurality of cooking appliances, an input indicating a first stage of a multi-stage cooking operation. The method also includes checking, by the first cooking appliance, a status of a second cooking appliance of the plurality of cooking appliances in response to the input indicating the first stage of the multi-stage cooking operation. The method may further include initiating the first stage of the multi-stage cooking operation by the first cooking appliance based on the status of the second cooking appliance or disabling the first stage of the multi-stage cooking operation by the first cooking appliance based on the status of the second cooking appliance.

### FIELD OF THE INVENTION

The subject matter of the present disclosure relates generally to cooking appliances, and more particularly to methods of performing a multi-stage cooking operation using a plurality of cooking appliances.

### BACKGROUND OF THE INVENTION

Consumers typically have multiple cooking appliances in their kitchens. In some cases, a consumer may desire to perform a multi-stage cooking operation using two or more of the multiple cooking appliances. For example, one or more food items, such as pieces of meat, may be defrosted in a first cooking appliance, e.g., microwave oven appliance, and then finished cooking in another, second, cooking appliance such as an oven or cooktop.

When the second cooking appliance is inoperable or unavailable, the multi-stage cooking operation may not be successfully completed. In such cases, the food items may have to be thrown out after the first stage of the multi-stage cooking operation. For example, defrosted meat that is not completely cooked (e.g., when the second cooking appliance in which the meat would have finished cooking after defrosting in unavailable) may have to be thrown away.

Accordingly, improved systems and methods for carrying out, and completing, a multi-stage cooking operation using multiple cooking appliances would be desirable.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a plurality of cooking appliances is provided. The method includes receiving, by a first cooking appliance of the plurality of cooking appliances, an input indicating a first stage of a multi-stage cooking operation. The method also includes checking, by the first cooking appliance, a status of a second cooking appliance of the plurality of cooking appliances in response to the input indicating the first stage of the multi-stage cooking operation. The method further includes initiating the first stage of the multi-stage cooking operation by the first cooking appliance based on the status of the second cooking appliance.

In another exemplary embodiment, a method of operating a plurality of cooking appliances is provided. The method includes receiving, by a first cooking appliance of the plurality of cooking appliances, an input indicating a first stage of a multi-stage cooking operation. The method also includes checking, by the first cooking appliance, a status of a second cooking appliance of the plurality of cooking appliances in response to the input indicating the first stage of the multi-stage cooking operation. The method further includes disabling the first stage of the multi-stage cooking operation by the first cooking appliance based on the status of the second cooking appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a perspective view of the exemplary cooking appliance of FIG. 1, wherein the door is an open position.

FIG. 3 provides a sectional view of the exemplary cooking appliance of FIG. 2.

FIG. 4 provides a front view of an exemplary cooking appliance according to one or more example embodiments of the present subject matter.

FIG. 5 provides a schematic perspective view of the cooking appliance of FIG. 4.

FIG. 6 provides a schematic perspective view of another embodiment of the cooking appliance of FIG. 4.

FIG. 7 provides a front view of another exemplary cooking appliance according to one or more example embodiments of the present subject matter.

FIG. 8 provides a section view of the cooking appliance of FIG. 7.

FIG. 9 provides a schematic diagram of a plurality of cooking appliances in communication with each other and with a remote database according to one or more embodiments of the present disclosure.

FIG. 10 provides a flow chart diagram illustrating a method according to one or more example embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents. As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components.

The present disclosure generally pertains to a systems and methods including multiple cooking appliances. A plurality of cooking appliances according to the present disclosure may include any two or more of the following example appliances, as well as other cooking appliances as will be recognized and understood by those of ordinary skill in the art.

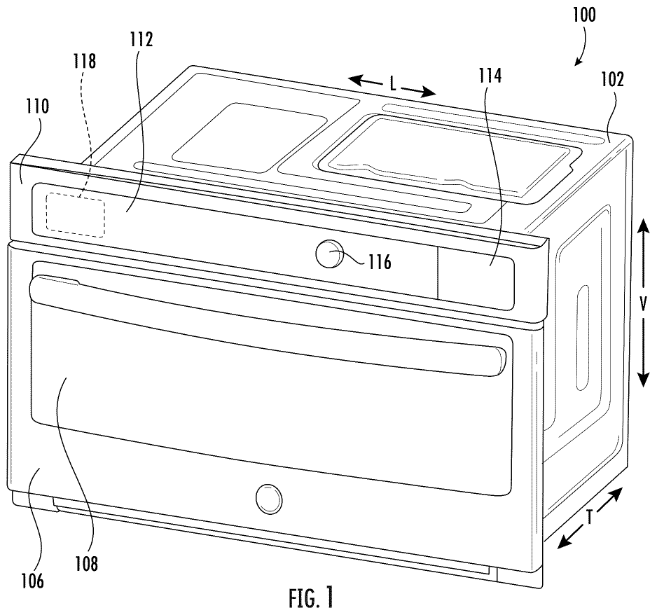

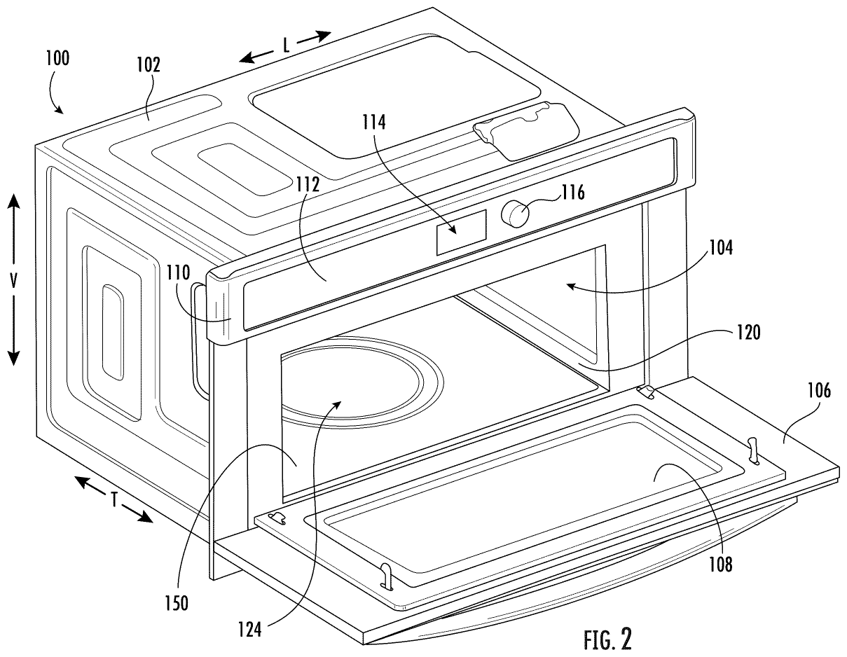

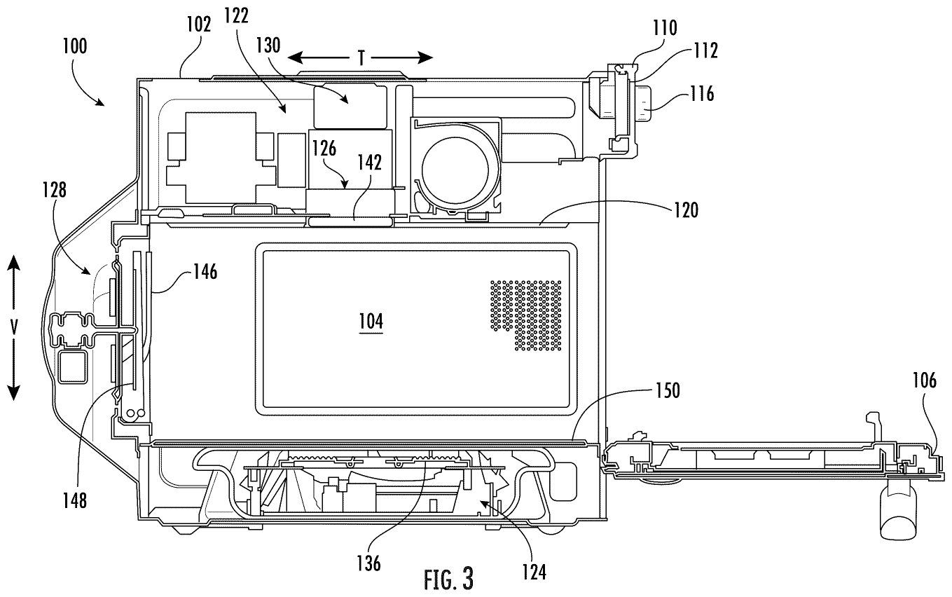

Turning now to FIGS. 1 through 3, various views are provided of a cooking appliance 100 according to exemplary embodiments of the present disclosure. Specifically, FIGS. 1 and 2 provide perspective views of cooking appliance 100 having a door 106 in an open position and a closed position, respectively. FIG. 3 provides a side, sectional view of cooking appliance 100, wherein door 106 is in the open position.

Generally, cooking appliance 100 includes a housing or cabinet 102 that defines a mutually-orthogonal vertical direction V, lateral direction L, and transverse direction T. Within cabinet 102, cooking appliance 100 defines a cooking chamber 104 in which food items can be received. In some embodiments, a door 106 is rotatably mounted to move between the open position and the closed position. As shown, the open position permits access to cooking chamber 104 while the closed position restricts access to cooking chamber 104. A window in door 106 may be provided (e.g., for viewing food items in the cooking chamber 104). Additionally or alternatively, a handle may be secured to door 106 (e.g., to rotate therewith). The handle can be formed of plastic, for example, and can be injection molded.

In certain embodiments, cooking appliance 100 includes a control panel frame 110 on or as part of cabinet 102. A control panel 112 may be mounted within control panel frame 110. Generally, control panel 112 includes a display device 114 for presenting various information to a user. Control panel 112 may also include one or more input devices (e.g., tactile buttons, knobs, touch screens, etc.). In optional embodiments, the input devices of control panel 112 include a knob or dial 116. Selections may be made by rotating dial 116 clockwise or counter-clockwise, and when the desired selection is displayed, pressing dial 116. For example, many meal cook cycles and other cooking algorithms can be preprogrammed in or loaded onto a memory device of a controller 118 of cooking appliance 100 for many different food items types (e.g., pizza, fried chicken, French fries, potatoes, etc.), including simultaneous preparation of a group of food items of different food types comprising an entire meal. Instructions or selections may be displayed on display device 114. In optional embodiments, display device 114 can be used as an input device. For instance, display device 114 may be a touchscreen device, as is understood.

In exemplary embodiments, cabinet 102 of cooking appliance 100 includes an inner shell 120. Inner shell 120 of cabinet 102 delineates the interior volume of cooking chamber 104. Optionally, the walls of shell may be constructed using high reflectivity (e.g., at least about 70% reflectivity) stainless steel.

Cooking appliance 100 includes multiple cooking modules. In particular, cooking appliance 100 includes a microwave module 122 and a lower heater module 124 mounted within cabinet 102. In additional or alternative embodiments, cooking appliance 100 includes an upper heater module 126 or a convection module 128.

Generally, microwave module 122 includes a magnetron 130 mounted within the cabinet 102 (e.g., above cooking chamber 104) and in communication (e.g., fluid or transmissive communication) with the cooking chamber 104 to direct microwave radiation or microwaves thereto. In other words, the microwave module 122 delivers microwave radiation into cooking chamber 104.

Below microwave module 122, lower heater module 124 may be mounted within cabinet 102. For instance, lower heater module 124 may include a heating coil 136 mounted below cooking chamber 104. The heating coil 136 may be, e.g., an induction heating coil or a resistive heating coil. The heating coil 136 may be in communication (e.g., transmissive communication) with cooking chamber 104 for heating objects, e.g., food items and/or cooking utensils, positioned within the cooking chamber 104.

Upper heater module 126 can include one or more heating elements 142. For instance, upper heater module 126 can include one or more electric heating elements, such as a resistive heating element (e.g., sheathed resistive heater) or a radiant heating element (e.g., a halogen cooking lamp) in thermal communication with cooking chamber 104. Upper heater module 126 may be mounted within or above cooking chamber 104 or otherwise spaced apart from microwave module 122.

Convection module 128 may include a sheathed heater 146 and a convection fan 148. Convection fan 148 is provided for blowing or otherwise moving air over sheathed heater 146 of convection module 128 and into cooking chamber 104 (e.g., for convection cooking).

The specific heating elements of upper and lower heater modules 126 and 124, convection module 128, and magnetron 130 of microwave module 122 can vary from embodiment to embodiment, and the elements and system described above are exemplary only. For example, the upper heater module 126 or convection module 128 can include any combination of heaters including combinations of halogen lamps, ceramic lamps, or sheathed heaters. As another example, the cooking appliance 100 may also include only the microwave module 122 without additional heating elements or heater modules.

As shown, cooking appliance 100 may include a controller 118. Controller 118 of cooking appliance 100 can include one or more processor(s) and one or more memory device(s). The processor(s) of controller 118 can be any suitable processing device, such as a microprocessor, microcontroller, integrated circuit, or other suitable processing device. The memory device(s) of controller 118 can include any suitable computing system or media, including, but not limited to, non-transitory computer-readable media, RAM, ROM, hard drives, flash drives, or other memory devices. The memory device(s) of controller 118 can store information accessible by the processor(s) of controller 118 including instructions that can be executed by the processor(s) of controller 118 in order to execute various cooking operations or cycles (e.g., a meal cook cycle). Controller 118 is communicatively coupled with various operational components of cooking appliance 100, such as components of microwave module 122, upper heater module 126, lower heater module 124, convection module 128, or control panel 112 (e.g., display device 114 or dial 116), the various control buttons, etc. Input/output (“I/O”) signals may be routed between controller 118 and control panel 112 as well as other operational components of cooking appliance 100. Controller 118 can execute and control cooking appliance 100 in various cooking operations or cycles, such as precision cooking, which includes meal cook, microwave, induction, or convection/bake modes.

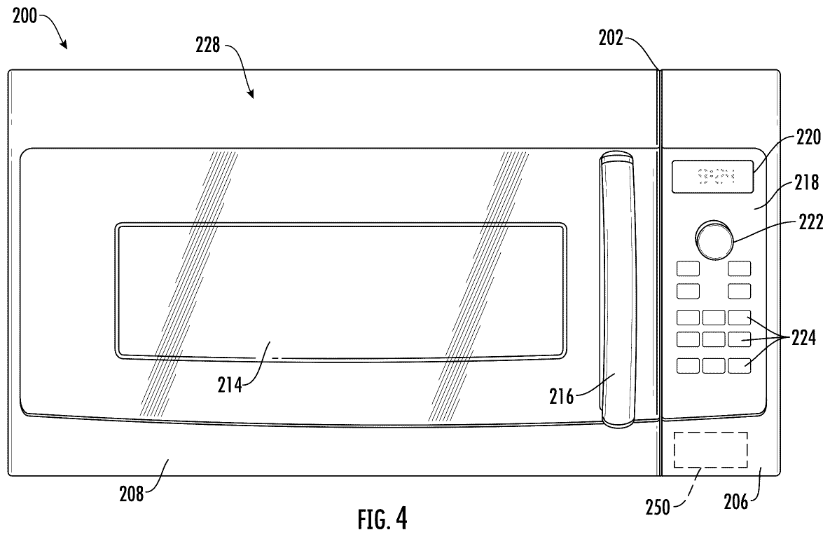

FIG. 4 provides a front view of a cooking appliance 200 according to another example embodiment of the present subject matter. Cooking appliance 200 may, in some example embodiments, be an “over-the-range” oven. In other example embodiments, the cooking appliance 200 may be a countertop oven, a wall oven, or may be provided in various other oven configurations as will be recognized by those of skill in the art.

Cooking appliance 200 includes a housing or casing 202 that defines a cooking cavity 228. Food items can be received within cooking cavity 228. A door 208 is rotatably mounted to casing 202 and is movable between an open position and a closed position (shown in FIG. 4) to provide selective access to cooking cavity 228. A window 214 in door 208 is provided for viewing food items in the cooking cavity 228, and a handle 216 is secured to door 208. Handle 216 can be formed of plastic, for example, and can be injection molded.

As may be seen, e.g., in FIGS. 4 through 6, the cooking appliance 200 may define a vertical direction V, a lateral direction L, and a transverse direction T. The vertical direction V, the lateral direction L, and the transverse direction T may be mutually perpendicular. In particular, the cooking appliance 200 may extend between a top and a bottom along the vertical direction, between a left side and a right side along the lateral direction L, and between a front and a back along the transverse direction T. For example, “front,” “back,” “left,” and “right” may be defined from the perspective of a user standing in front of the cooking appliance 200 to access the cooking cavity 228 therein, e.g., via the door 208.

Cooking appliance 200 also includes a control panel frame 206. A control panel 218 is mounted within control panel frame 206. Control panel 218 includes a display device 220 for presenting various information to a user. Control panel 218 also includes one or more input devices. For this embodiment, the input devices of control panel 218 include a knob or dial 222 and tactile control buttons 224. Selections are made by rotating dial 222 clockwise or counter-clockwise, and when the desired selection is displayed, pressing dial 222. For example, many cooking cycles and other cooking algorithms can be preprogrammed in or loaded onto a memory device of a controller 250 of cooking appliance 200. Additionally, new or updated cooking cycles may be downloaded to the memory device of the controller 250, such as from a remote database, e.g., a cloud server, via a network communications module of the controller 250 and stored in the memory device. One or more cooking parameters can be selected by rotating dial 222 until the desired value for the parameter is displayed and then pressing dial 222, and the process may be repeated for each parameter when more than one parameter is being selected or adjusted. Instructions and selections are displayed on display device 220. Furthermore, in some embodiments, display device 220 can also be used as an input device. For instance, in such embodiments, display device 220 can be a touchscreen device. In some embodiments, display device 220 is the only input device of control panel 218.

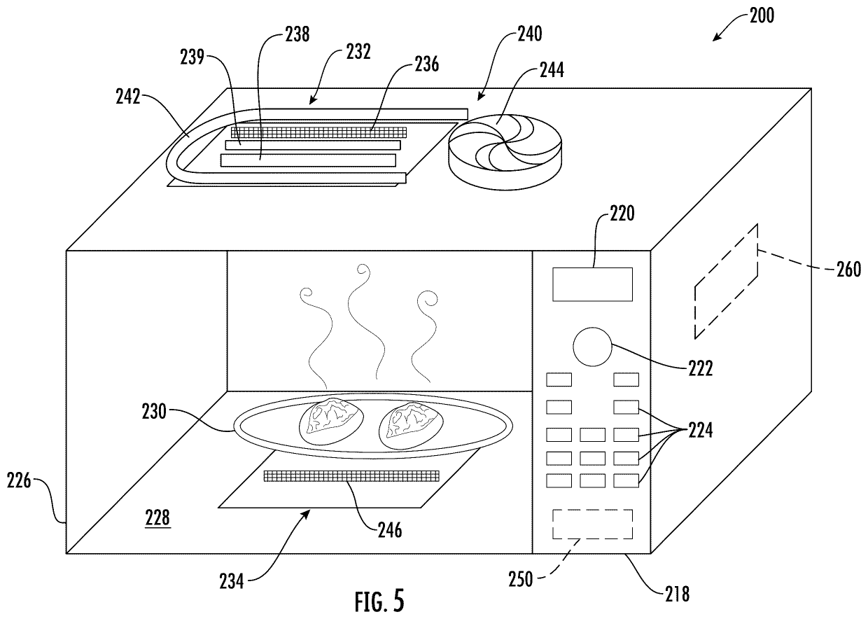

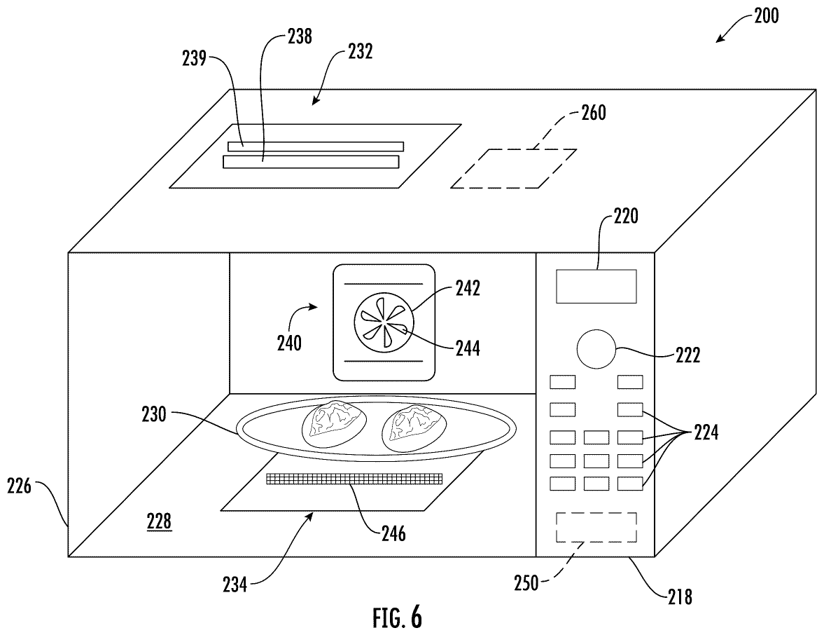

FIG. 5 provides a schematic view of cooking appliance 200 in one or more example embodiments and FIG. 6 provides a schematic view of cooking appliance 200 in one or more additional example embodiments. As shown in FIGS. 5 and 6, in some example embodiments, casing 202 (FIG. 4) of cooking appliance 200 includes a shell 226. Shell 226 of casing 202 delineates the interior volume of cooking cavity 228. The walls of shell 226 may be constructed using high reflectivity (e.g., at least about 70% reflectivity) stainless steel. A turntable 230 is located in cooking cavity 228 and is rotatable about an axis of rotation, e.g., for rotating food items during a cooking operation.

Further, cooking appliance 200 includes a microwave module 260, an upper heater module 232, a lower heater module 234, and a convection module 240. In the example embodiment of FIG. 5, the convection module 240 is positioned above the cooking cavity 228. FIG. 6 schematically illustrates an additional example embodiment of the cooking appliance 200, where the convection module 240 (including sheath heater 242 and convection fan 244) is provided at a back of the cooking cavity 228. In some embodiments, microwave module 260 is located on a side of cooking cavity 228 (e.g., as illustrated in FIG. 5), while in other example embodiments, the microwave module 260 may be located above the cooking cavity 228 (e.g., as illustrated in FIG. 6). The microwave module 260 delivers microwave energy into cooking cavity 228. In some embodiments, the microwave module 260 includes a magnetron to provide the microwave energy. In other embodiments, the microwave module 260 may also or instead include a solid-state radio frequency device, e.g., a low-voltage printed circuit board with semiconductors embedded therein which output microwave energy at various frequencies and power output levels. Upper heater module 232 can include one or more heating elements. For instance, upper heating module 232 can include one or more halogen cooking lamps and/or one or more ceramic heaters. For the embodiment illustrated in FIG. 2, upper heating module 232 includes a ceramic heater 236 and a halogen cooking lamp 238. In some example embodiments, upper heater module 232 has at least two halogen lamps 238, 239 configured to deliver radiant and thermal energy into the cooking cavity 228, such as in the example embodiment depicted in FIG. 6.

Convection module 240 includes a sheath heater 242 and a convection fan 244. Convection fan 244 is provided for blowing or otherwise moving air over sheath heater 242 of convection module 240 and into cooking cavity 228, e.g., for convection cooking. Lower heater module 234 includes at least one heating element. The heating element of lower heater module 234 can be a ceramic heater or a halogen lamp, for example. For the example embodiments illustrated in FIGS. 2 and 3, the heating element of lower heater module 234 is illustrated as a ceramic heater 246. In various embodiments, cooking appliance 200 may be a 240V cooking appliance or a 120V cooking appliance, for example.

The specific heating elements of upper and lower heater modules 232, 234, convection module 240, and radio frequency (RF) generation system of microwave module 260 (e.g., a magnetron or solid state RF generation system) can vary from embodiment to embodiment, and the elements and systems described above are exemplary only. For example, the upper heater module 232 can include any combination of heaters including combinations of halogen lamps, ceramic lamps, and/or sheath heaters. Similarly, lower heater module 234 can include any combination of heaters including combinations of halogen lamps, ceramic lamps, and/or sheath heaters. In addition, the heaters can all be one type of heater. The specific ratings and number of lamps and/or heaters utilized in the upper and lower modules 232, 234 and convection module 240 can vary from embodiment to embodiment. Generally, the combinations of lamps, heaters, and RF generation system is selected to provide the desired cooking characteristics for precision cooking in various modes and/or operations.

As shown in FIGS. 4 through 6, cooking appliance 200 includes a controller 250. Controller 250 of cooking appliance 200 can include one or more processor(s) and one or more memory device(s). The processor(s) of controller 250 can be any suitable processing device, such as a microprocessor, microcontroller, integrated circuit, or other suitable processing device. The memory device(s) of controller 250 can include any suitable computing system or media, including, but not limited to, non-transitory computer-readable media, RAM, ROM, hard drives, flash drives, or other memory devices. The memory device(s) of controller 250 can store information accessible by the processor(s) of controller 250 including instructions that can be executed by the processor(s) of controller 250 in order to execute various cooking operations or cycles, e.g., a meal cook cycle. Controller 250 is communicatively coupled with various operational components of cooking appliance 200, such as components of microwave module 260, upper heater module 232, lower heater module 234, convection module 240, and control panel 218, including display device 220, dial 222, the various control buttons 224, etc. Input/output (“I/O”) signals may be routed between controller 250 and control panel 218 as well as other operational components of cooking appliance 200. Controller 250 can execute and control cooking appliance 200 in various cooking operations or cycles, such as precision cooking, which includes microwave and convection/bake modes.

Cooking appliance 200 can operate in various modes or cycles, and the descriptions set forth herein are exemplary only. In addition, operation and use of cooking appliance 200 is not limited to a specific order of steps. Various steps can be performed in orders different from the exemplary order described herein.

In some embodiments, the cooking appliance 200 may be operable in one or more convection/bake modes. In one example convection/bake mode, a user selects “Convection/Bake” from control panel 218, and then uses dial 222 to select a temperature and cook time. Lower ceramic heater 246 and sheath heater 242 are then energized to preheat the air in cooking cavity 228. The food is then placed in cooking cavity 228 and cooking begins. During the cooking cycle, convection fan 244 circulates air to assure even cooking. Controller 250 can activate convection fan 244 (e.g., via one or more command signals) such that convection fan 244 moves air over sheath heater 242, and in some embodiments heating elements of upper heater module 232. In this way, heated air is moved into cooking cavity 228, e.g., for convection cooking.

Cooking appliance 200 may also operate in one or more microwave modes, for example a microwave only mode, or the microwave module 260 may operate in conjunction with one or more various other heating modules in other modes. Generally, for the modes which utilize microwave module 260, the user places food in cooking cavity 228 on turntable 230. The user then selects “Microwave,” “Express,” or other applicable cooking mode (e.g., a cooking cycle which utilizes the microwave module in conjunction with other heating modules) from control panel 218. Dial 222, for example, can be utilized to select the cooking mode, e.g., rotating the dial 222 until the cooking mode is displayed or highlighted, and the user may then select “Start” from control panel 218. The microwave module 260 is then energized in accordance with the user selections. In some embodiments, the user can select the desired cook time and power level and then may select “START” to commence the microwave only cooking operation.

In some embodiments, such as when the cooking appliance 200 is operated according to a predetermined or predefined precision cooking cycle, the cooking appliance 200 may operate one or more of the convection module 240, the lower heating module 234, the upper heating module 232, and the microwave module 260 in various combinations during a single cycle. For example, some embodiments may include operating two or more of the modules at various times, sequentially and/or simultaneously, during a single cycle. Such cycles may also include varying the rotational speed and/or direction of the turntable 230 at various points in time during the cycle. In various embodiments, the rotation of the turntable 230 may be controlled by software, and may be controlled based on an operating mode of the cooking appliance 200, cooking cycle sequences, and/or user input. Also, when one or more heating modules of the cooking appliance 200 are adjusted according to the predefined precision cooking cycle, such adjustments may be synchronized with the rotation of the turntable 230.

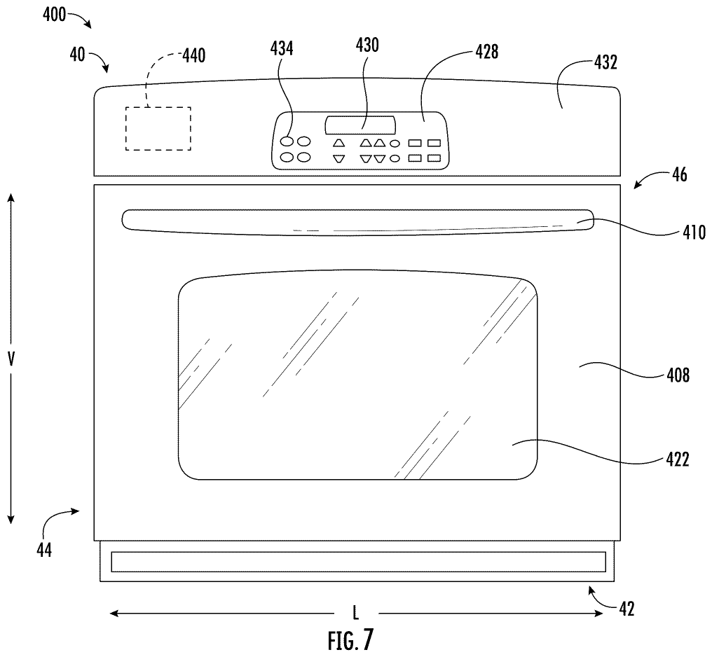

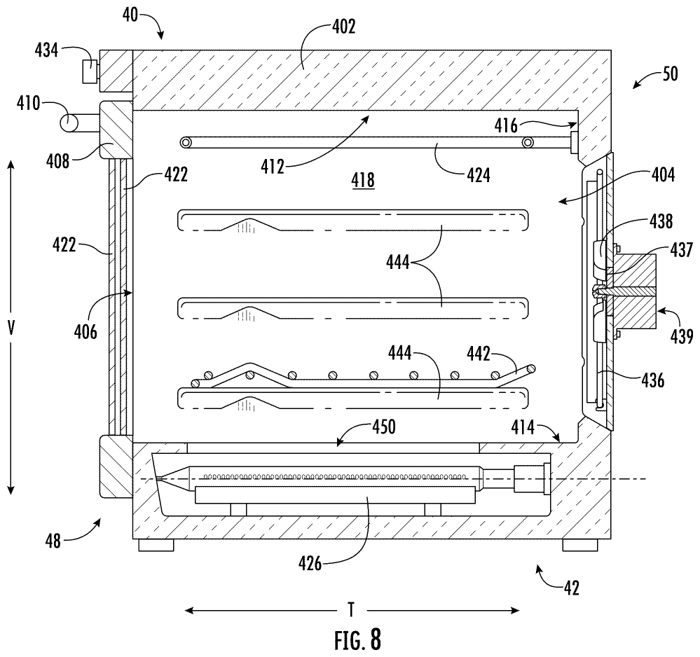

FIGS. 7 and 8 illustrate yet another exemplary cooking appliance, which in this example is an oven appliance 400 according to an exemplary embodiment of the present subject matter. Oven appliance 400 includes an insulated cabinet 402 which defines a vertical direction V, a lateral direction L, and a transverse direction T. The vertical, lateral, and transverse directions V, L, and T are mutually perpendicular and form an orthogonal direction system. Cabinet 402 extends between a top portion 40 and a bottom portion 42 along the vertical direction V. Cabinet 402 extends between a left side 44 and a right side 46 along the lateral direction L and between a front portion 48 and a back portion 50 along the transverse direction T.

Still referring to FIGS. 7 and 8, for this exemplary embodiment, oven appliance 400 includes an insulated cabinet 402 with an interior cooking chamber 404 defined by a top wall 412, a floor or bottom wall 414, a back wall 416, and a pair of opposing side walls 418. Cooking chamber 404 is configured for the receipt of one or more food items to be cooked. Oven appliance 400 includes a door 408 pivotally mounted to cabinet 402 at the opening 406 of cabinet 402 to permit selective access to cooking chamber 404 through opening 406. A handle 410 is mounted to door 408 and assists a user with opening and closing door 408. For example, a user can pull on handle 410 to open or close door 408 and access cooking chamber 404.

Oven appliance 400 can include a seal (not shown) between door 408 and cabinet 402 that assists with maintaining heat and cooking vapors within cooking chamber 404 when door 408 is closed as shown in FIGS. 7 and 8. Multiple parallel glass panes 422 provide for viewing the contents of cooking chamber 404 when door 408 is closed and assist with insulating cooking chamber 404. A baking rack 442 is positioned in cooking chamber 404 for the receipt of food items or utensils containing food items. Baking rack 442 is slidably received onto embossed ribs or sliding rails 444 such that rack 442 may be conveniently moved into and out of cooking chamber 404 when door 408 is open.

One or more heating elements may be included at the top, bottom, or both of cooking chamber 404 to provide heat to cooking chamber 404 for cooking. Such heating element(s) can be gas, electric, microwave, or a combination thereof. For example, in the embodiment shown in FIG. 5, oven appliance 400 includes a top heating element 424 which, in the illustrated example embodiment is an electric resistance heating element 424, and a bake heating element or bottom heating element 426, which, in the illustrated example embodiment is a gas burner 426, and bottom heating element 426 is positioned adjacent to and below bottom wall 414.

Also as may be seen in FIG. 8, the gas burner 426 is positioned within the cabinet 402 and outside of the chamber 404. In some embodiments, for example as illustrated in FIG. 8, the gas burner 426 may be a bake heating element or bottom heating element and may be positioned below the chamber 404 and separated from the chamber 404 by a partition, e.g., the bottom wall 414 of the chamber 404. The gas burner 426 may be in thermal communication and in fluid communication with the chamber by a flow path extending through one or more apertures or openings 450 in the bottom wall 414. In at least some embodiments, the flow path may extend from the gas burner 426, e.g., from ports thereof, through the opening(s) 450, and into the cooking chamber 404.

In the illustrated example embodiment, oven appliance 400 also has a convection heating element 436 and convection fan 438 positioned adjacent back wall 416 of cooking chamber 404. Convection fan 438 is powered by a convection fan motor 439. Further, convection fan 438 can be a variable speed fan-meaning the speed of fan 438 may be controlled or set anywhere between and including, e.g., zero and one hundred percent (0%-100%). In certain embodiments, oven appliance 400 may also include a bidirectional triode thyristor (not shown), i.e., a triode for alternating current (TRIAC), to regulate the operation of convection fan 438 such that the speed of fan 438 may be adjusted during operation of oven appliance 400. The speed of convection fan 438 can be determined by controller 440. In addition, a sensor 437 such as, e.g., a rotary encoder, a Hall effect sensor, or the like, may be included at the base of fan 438, for example, between fan 438 and motor 439 as shown in the exemplary embodiment of FIG. 8, to sense the speed of fan 438. The speed of fan 438 may be measured in, e.g., revolutions per minute (“RPM”). In some embodiments, the convection fan 438 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity. Additionally, the convection heating features are optional and are shown and described herein solely by way of example. In other embodiments the oven appliance 400 may include different convection heating features or may not include convection heating features at all.

In various embodiments, more than one convection heater, e.g., more than one convection heating elements 436 and/or convection fans 438, may be provided. In such embodiments, the number of convection fans and convection heaters may be the same or may differ, e.g., more than one convection heating element 436 may be associated with a single convection fan 438. Similarly, more than one top heating element 424 and/or more than one bottom heating element 426 may be provided in various combinations, e.g., one top heating element 424 with two or more bottom heating elements 426, two or more bottom heating elements 426 with no top heating element 424, etc.

Oven appliance 400 includes a user interface 428 having a display 430 positioned on an interface panel 432 and having a variety of controls 434. Interface 428 allows the user to select various options for the operation of oven 400 including, e.g., various cooking and cleaning cycles. Operation of oven appliance 400 can be regulated by a controller 440 that is operatively coupled to, i.e., in communication with, user interface 428, heating elements 424, 426, and other components of oven 400 as will be further described. In some embodiments, display 430 can also be used as an input device. For instance, in such embodiments, display 430 can be a touchscreen device. In some embodiments, display 430 is the only input device on interface panel 432, e.g., the controls 434 may be omitted and the input functionality may be provided by the touchscreen display 430.

For example, in response to user manipulation of the user interface 428, controller 440 can operate the heating element(s). Controller 440 can receive measurements from one or more temperature sensors (not shown) which are in or in thermal communication with the cooking chamber 404. Controller 440 may also provide information such as a status indicator, e.g., a temperature indication, to the user with display 430. Controller 440 can also be provided with other features as will be further described herein.

Controller 440 may include a memory and one or more processing devices such as microprocessors, CPUs, or the like, such as general or special purpose microprocessors operable to execute programming instructions or micro-control code associated with operation of oven appliance 400. The memory may represent random access memory such as DRAM or read only memory such as ROM or FLASH. In one embodiment, the processor executes programming instructions stored in memory. The memory may be a separate component from the processor or may be included onboard within the processor. The memory can store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system, e.g., to execute exemplary methods of operating the oven appliance 400. Controller 440 may also be or include the capabilities of either a proportional (P), proportional-integral (PI), or proportional-integral-derivative (PID) control for feedback-based control implemented with, e.g., temperature feedback from one or more sensors such as temperature sensors and/or probes, etc.

Controller 440 may be positioned in a variety of locations throughout oven appliance 400. In the illustrated embodiment, controller 440 is located next to user interface 428 within interface panel 432. In other embodiments, controller 440 may be located under or next to the user interface 428, otherwise within interface panel 432, or at any other appropriate location with respect to oven appliance 400. Generally, controller 440 will be positioned within the cabinet 402. In the embodiment illustrated in FIG. 7, input/output (“I/O”) signals are routed between controller 440 and various operational components of oven appliance 400 such as heating elements 424, 426, 436, convection fan 438, controls 434, display 430, alarms, and/or other components as may be provided. In one embodiment, user interface 428 may represent a general purpose I/O (“GPIO”) device or functional block.

Although shown with touch type controls 434, it should be understood that controls 434 and the configuration of oven appliance 400 shown in FIGS. 7 and 8 is provided by way of example only. More specifically, user interface 428 may include various input components, such as one or more of a variety of electrical, mechanical, or electro-mechanical input devices including rotary dials, push buttons, and touch pads. User interface 428 may include other display components, such as a digital or analog display device designed to provide operational feedback to a user. User interface 428 may be in communication with controller 440 via one or more signal lines or shared communication busses.

While oven 400 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 434, as mentioned above, are possible. As another example, the oven appliance 400 may include multiple doors 408 instead of or in addition to the single door 408 illustrated. Such examples include a dual cavity oven, a French door oven, and others. As still another example, one or more of the illustrated heating elements may be substituted with microwave heating elements, or any other suitable heating elements. The examples described herein are provided by way of illustration only and without limitation.

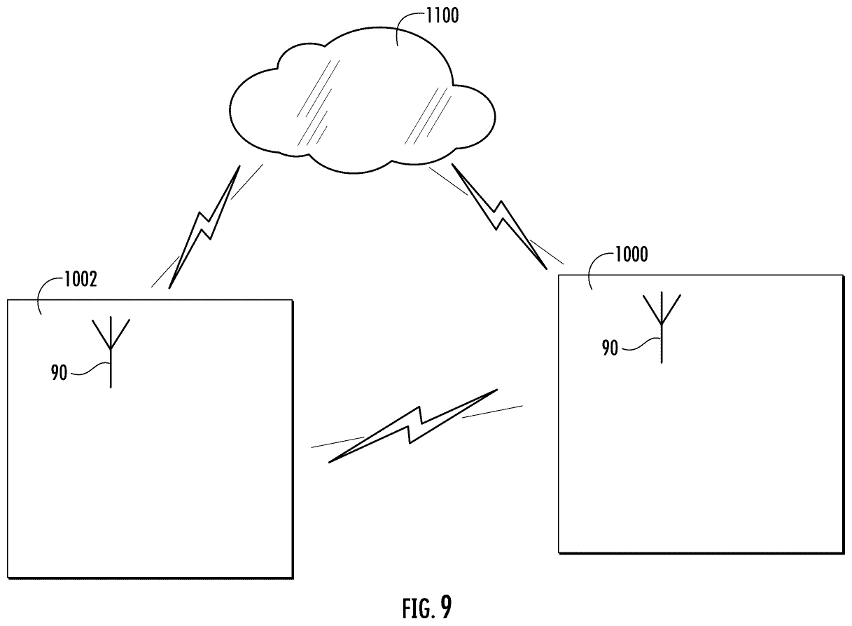

Turning now to FIG. 9, a general schematic is provided of a plurality of cooking appliances, such as a plurality which includes at least a first cooking appliance 1000 and a second cooking appliance 1002. Each cooking appliance may be any one of the exemplary cooking appliances 100, 200, or 400 described above, or other similar cooking appliances as will be recognized by those skilled in the art. Communication features of the cooking appliances are also illustrated. FIG. 9 schematically illustrates cooking appliances 1000 and 1002 which communicate wirelessly with each other and with one or more a remote computing devices, e.g., in the cloud 1100. For example, as illustrated in FIG. 9, each cooking appliance 1000 and 1002 may include an antenna 90 by which the appliance 1000 or 1002 communicates with, e.g., sends and receives signals to and from, the other appliance 1000 or 1002 and the cloud 1100. The appliances 1000 and 1002 may communicate with each other over a direct wireless communication link or over an indirect wireless communication link, such as via a remote server, a network, or cloud 1100.

The antenna 90 may be provided in or on a wireless communication module of each cooking appliance 1000 and 1002. The wireless communication module may be integrated with the controller of the cooking appliance or may be separate from and communicatively coupled to the controller. Thus, the controller may be in wireless communication with the cloud 1100 and the other cooking appliance, e.g., the controller may send and receive signals to and from the cloud 1100 and/or other cooking appliance over the air, via the antenna 90, and may operate the cooking appliance in accordance with data conveyed via such signals.

The cooking appliances 1000 and 1002 may be in communication with each other and with the cloud 1100 through various possible communication connections and interfaces. The appliances 1000 and 1002 may be matched in wireless communication, e.g., connected to the same wireless network. The appliances 1000 and 1002 may communicate with each other via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliances 1000 and 1002. For example, BLUETOOTH® Low Energy may advantageously minimize the power consumed by the exemplary methods and devices described herein due to the low power networking protocol of BLUETOOTH® Low Energy.

As mentioned above, the cooking appliances 1000 and 1002 may also be configured to communicate wirelessly with cloud 1100. The cloud 1100 is depicted schematically in FIG. 9 and explanation thereof is provided herein by way of example only and without limitation. More generally, the cooking appliances 1000 and 1002 may be in wireless communication with one or more remote computing devices, such as a remote database, a remote server, etc., in various network configurations and/or distributed computing environments, such as the fog or edge, as well as or instead of the cloud 1100. For example, the cloud 1100 may be or may include a remote database, e.g., a cloud-based data storage system. For example, the cooking appliances 1000 and 1002 may communicate with such remote database (and/or other remote computing device(s) as mentioned) over the Internet, which the cooking appliances 1000 and 1002 may access via WI-FI®, such as from a WI-FI® access point.

In some embodiments, methods according to the present disclosure may include commissioning one or both cooking appliances 1000 and 1002 in a remote computing device, e.g., in the cloud 1100, and commissioning the second cooking appliance 1002 may include linking the second cooking appliance 1002 to the first cooking appliance 1000. For example, commissioning each cooking appliance may be or may include an initial setup of the cooking appliance, such as connecting the cooking appliance to a WI-FI® network for the first time and/or adding the cooking appliance to a user account, e.g., in the cloud, in a remote database or other similar remote device for user account information storage and retrieval.

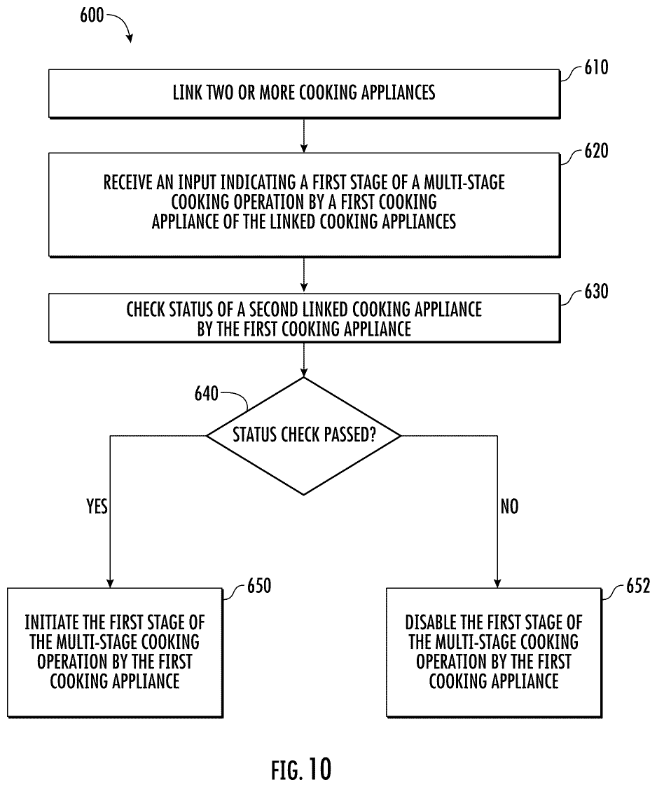

As illustrated in FIG. 10, embodiments of the present disclosure also include methods of operating a plurality of cooking appliances, such as the exemplary cooking method 600 illustrated in FIG. 10. As mentioned, the plurality of cooking appliances may include any of the foregoing exemplary appliances described herein above, e.g., any two or more of a cooktop, a multi-function oven appliance, and/or a range appliance. Further, the plurality of appliances may also include, e.g., a microwave oven (such as a multi-function cooking appliance including a microwave feature or a microwave-only cooking appliance). For example, the microwave oven appliance may include features generally similar to the microwave features described above in context of the cooking appliance 100 or the cooking appliance 200 (multi-function oven appliance), with or without additional heating elements, such as a microwave-only oven appliance, or a microwave oven appliance which also includes one or more additional heating modules, such as an induction heating module, a convection heating module, and/or one or more heat lamps, etc. Also by way of example, one or more of the cooking appliances may include various combinations of heating modules and/or heating elements as in any of the foregoing examples, such as an oven appliance with only electric radiant heating (e.g., without convection), an oven appliance with gas bake heating element and convection heating, an oven appliance with ceramic heating modules and heat lamps, among numerous other possible combinations. As another example, the plurality of cooking appliances may also include an air fryer, toaster oven, pressure cooker, slow cooker, or other similar cooking appliances as will be recognized by those of ordinary skill in the art.

As shown in FIG. 10, the method 600 may include (610) linking a plurality of cooking appliances, e.g., two or more cooking appliances. As described above, the plurality of cooking appliances may be linked for wireless communication, such as directly (e.g., via BLUETOOTH® or other local, short-range communication protocols) or indirectly (e.g., via the internet, such as one or more remote computing devices, e.g., in the cloud or other distributed computing environment).

Method 600 may further include (620) receiving an input indicating a first stage of a multi-stage cooking operation. The input may be received by a first cooking appliance of the plurality of cooking appliances. The input may be received indirectly, such as from a remote user interface device (e.g., smartphone), or directly on a local user interface of the first cooking appliance. The first stage of the multi-stage cooking operation may be, for example, a defrost operation. More generally, the first stage of the multi-stage cooking operation may provide an initial preparation of one or more food items for further cooking (e.g., subsequent stages in the multi-stage cooking operation) in another cooking appliance, e.g., a second cooking appliance of the plurality of linked cooking appliances.

Method 600 may also include (630) checking, by the first cooking appliance, a status of the second cooking appliance of the plurality of cooking appliances in response to the input indicating the first stage of the multi-stage cooking operation. For example, checking the status of the second cooking appliance may include requesting fault data from the second cooking appliance by the first cooking appliance and receiving, by the first cooking appliance, fault data from the second cooking appliance.

Method 600 may further include (640) determining whether the status check was passed, e.g., determining whether the second cooking appliance is operating as expected or is in a fault condition. For example, The fault data received from the second cooking appliance may include a no fault status of the second cooking appliance or a fault status of the second cooking appliance. When the second cooking appliance is in a fault condition (e.g., when the status check is not passed), the multi-stage operation may be unable to be successfully completed, and the food item (or items) prepared in the first stage may ultimately be wasted if the food item(s) cannot be completely cooked.

When the status check is passed (e.g., when the received fault data includes a no fault status of the second cooking appliance), method 600 may proceed from (640) along the “YES” arrow to (650) initiating the first stage of the multi-stage cooking operation by the first cooking appliance based on the status of the second cooking appliance. Those of ordinary skill in the art will recognize that initiating the first stage of the multi-stage cooking operation includes activating one or more heating elements or heater modules of the first cooking appliance, e.g., such that initiating the first stage of the multi-stage cooking operation includes tangible work and results in a change of status of one or more items of matter, such as the heating element itself and food items in the first cooking appliance. In such embodiments, the multi-stage cooking operation may then be completed, e.g., method 600 may also include initiating a second stage of the multi-stage cooking operation by the second cooking appliance after the first stage of the multi-stage cooking operation.

When the status check is not passed (e.g., when the received fault data includes a fault status of the second cooking appliance), method 600 may proceed from (640) along the “NO” arrow to (652) disabling the first stage of the multi-stage cooking operation by the first cooking appliance based on the status of the second cooking appliance. Disabling the first stage of the multi-stage cooking operation by the first cooking appliance based on the status of the second cooking appliance may advantageously prevent or reduce food waste, e.g., by preventing starting the multi-stage cooking operation when the second cooking appliance in unavailable to complete the multi-stage cooking operation, such that partially prepared food items will not need to be thrown away. Accordingly, disabling the first stage of the multi-stage cooking operation improves the operation of the first cooking appliance, such as by avoiding inefficient waste of energy for partially cooking food that is not able to be completely cooked, and by avoiding wasted food as mentioned.

In addition, a user notification may be provided after disabling the first stage of the multi-stage cooking operation. The user notification may be provided on a local user interface of the first cooking appliance and/or on a remote user interface device (e.g., smartphone, personal computer, and the like). In such embodiments, the user notification may include an indication of the status of the second cooking appliance.

In some embodiments, the disabling of the first stage may be overridden. For example, such embodiments may include receiving, by the first cooking appliance of the plurality of cooking appliances, a second input indicating the first stage of a multi-stage cooking operation after disabling the first stage of the multi-stage cooking operation (and, in at least some embodiments, after providing the user notification). Such embodiments may further include initiating the first stage of the multi-stage cooking operation by the first cooking appliance in response to the second input. Thus, in such embodiments, the second input (e.g., the user presses the START button again) indicates the user still wants to perform the first stage (e.g., defrost operation) of the multi-stage cooking operation, and so the first cooking appliance (e.g., microwave) overrides the disabled first stage operation and forcibly starts the first stage operation, such as the defrost mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a plurality of cooking appliances, the method comprising:
receiving, by a first cooking appliance of the plurality of cooking appliances, an input indicating a first stage of a multi-stage cooking operation;
checking, by the first cooking appliance, a status of a second cooking appliance of the plurality of cooking appliances in response to the input indicating the first stage of the multi-stage cooking operation; and
initiating the first stage of the multi-stage cooking operation by the first cooking appliance based on the status of the second cooking appliance.

2. The method of claim 1, further comprising linking the first cooking appliance and the second cooking appliance prior to receiving the input indicating the first stage of the multi-stage cooking operation.

3. The method of claim 2, wherein linking the first cooking appliance and the second cooking appliance comprises establishing a direct wireless communication link between the first cooking appliance and the second cooking appliance.

4. The method of claim 2, wherein linking the first cooking appliance and the second cooking appliance comprises linking the first cooking appliance and the second cooking appliance in a remote computing device.

5. The method of claim 1, wherein the first stage of the multi-stage cooking operation is a defrost operation.

6. The method of claim 1, wherein checking the status of the second cooking appliance by the first cooking appliance comprises requesting fault data from the second cooking appliance by the first cooking appliance and receiving, by the first cooking appliance, fault data from the second cooking appliance.

7. The method of claim 6, wherein the fault data from the second cooking appliance comprises a no fault status of the second cooking appliance.

8. The method of claim 1, further comprising initiating a second stage of the multi-stage cooking operation by the second cooking appliance after the first stage of the multi-stage cooking operation.

9. A method of operating a plurality of cooking appliances, the method comprising:
receiving, by a first cooking appliance of the plurality of cooking appliances, an input indicating a first stage of a multi-stage cooking operation;
checking, by the first cooking appliance, a status of a second cooking appliance of the plurality of cooking appliances in response to the input indicating the first stage of the multi-stage cooking operation; and
disabling the first stage of the multi-stage cooking operation by the first cooking appliance based on the status of the second cooking appliance.

10. The method of claim 9, further comprising providing a user notification after disabling the first stage of the multi-stage cooking operation, the user notification comprising an indication of the status of the second cooking appliance.

11. The method of claim 9, further comprising receiving, by the first cooking appliance of the plurality of cooking appliances, a second input indicating the first stage of a multi-stage cooking operation, and initiating the first stage of the multi-stage cooking operation by the first cooking appliance in response to the second input.

12. The method of claim 9, further comprising linking the first cooking appliance and the second cooking appliance prior to receiving the input indicating the first stage of the multi-stage cooking operation.

13. The method of claim 12, wherein linking the first cooking appliance and the second cooking appliance comprises establishing a direct wireless communication link between the first cooking appliance and the second cooking appliance.

14. The method of claim 12, wherein linking the first cooking appliance and the second cooking appliance comprises linking the first cooking appliance and the second cooking appliance in a remote computing device.

15. The method of claim 9, wherein the first stage of the multi-stage cooking operation is a defrost operation.

16. The method of claim 9, wherein checking the status of the second cooking appliance by the first cooking appliance comprises requesting fault data from the second cooking appliance by the first cooking appliance and receiving, by the first cooking appliance, fault data from the second cooking appliance.

17. The method of claim 16, wherein the fault data from the second cooking appliance comprises a fault status of the second cooking appliance.
